(19) United States
(12) Patent Application Publication
(10) Pub. No.: US 2002/0124945 A1
(43) Pub. Date: Sep. 12, 2002

(54) In-mold label with perforations

(76) Inventors: Ron Muir, Keller, TX (US); Rene Lachance, St-Constant (CA)

Correspondence Address: DORSEY & WHITNEY, LLP, SUITE 4700, 370 SEVENTEENTH STREET, DENVER, CO, 80202-5647, US

(21) Appl. No.: 09/780,062

(22) Filed: Feb. 9, 2001

Related U.S. Application Data
(60) Provisional application No. 60/181,801, filed on Feb. 11, 2000.

(51) Int. Cl. B29C 49/24; B32B 3/10; B32B 31/04

(52) U.S. Cl. 156/245; 428/137; 428/131; 264/509

(57) ABSTRACT

An improved method for preparing a molded plastic container with embedded label in which the label contains one or more perforations to reduce blistering during the blow molding process. In a preferred embodiment, the perforations are larger on one side of the label than the other to facilitate the release of gases that otherwise would be trapped behind the label.

This application claims priority from U.S. provisional patent application Serial No. 60/181,801 filed on Feb. 11, 2000.

### I. FIELD OF THE INVENTION

This invention relates to an improved in-mold label and a method and apparatus for creating and using the same.

### II. BACKGROUND OF THE INVENTION

In-mold labeling is a method for pre-decorating a wide variety of plastic containers by embedding labels during the blow molding process used to fabricate the containers. Blow molding is a process well-known in the art. One type of blow molding process, extrusion blow molding, starts when granulated plastic resin material is melted into a molten state. The liquid plastic is formed into a “parison,” often cylindrical in shape, which is then placed between two mold halves. The mold halves come together and a blow-pin is injected into the parison. The blow-pin exerts a blow pressure that reshapes the parison to the geometric design of the mold cavity. The air in the mold surrounding the parison escapes through tiny gaps or vents between the mold halves. The molds are then cooled with water, which changes the parison back to a solid phase, thus creating a solid plastic container in the shape of the mold.

In-mold labeling is known in the art. During the blow molding process, an in-mold label is placed inside the mold by a device such as a robotic arm. The in-mold label can be held in place against the inside wall of the mold by suction from vacuum ports or other techniques. Generally, an in-mold label consists of three layers, including an adhesive, a label substrate, and ink/overprint. When the in-mold label is heated during the blow molding process, the adhesive activates to help maintain adhesion with the parison. When the parison cools, the in-mold label becomes part of the finished plastic container, and the outer surface of the label is nearly flush with the outer surface of the plastic container.

In-mold labeling has numerous advantages over the traditional method of gluing labels to the exterior of manufactured containers. In-mold labels are embedded within the outer surface of the plastic bottle instead of being applied to the outer surface, providing the finished container with a more aesthetically pleasing appearance. The in-mold labeling process of decorating a container is more cost effective than the traditional post-mold application process. This is because the bottle is predecorated, and the filling process is not slowed by the labeling of individual containers. Additionally, the label itself acts as a deterrent to possible product seepage through the container wall. This is known in the art as “product migration” and occurs when the product moves through the container wall through microscopic channels.

When a label is applied to the wall of the container as it is formed, the label becomes an integral part of the container. The label displaces a certain amount of the original plastic material. Due to this displacement, a certain amount of source material is saved which thereby reduces the cost of material for each container. The in-mold label also can add structural rigidity and strength if fully bonded to the container.

A disadvantage of traditional in-mold labeling is that during the blow molding process, the in-mold label does not always achieve full adhesion to the container. This difficulty occurs in the molding process when the parison material contacts the label in a manner that entraps gases emitted by the adhesive and/or the parison material. The trapped gases act as a barrier between the label and the parison material. This vapor barrier prevents the label from fully contacting the container forming material. As the molding process continues, the trapped gases tend to concentrate in varying sized pockets between the label and the container. This separation can either prevent or decrease the quality of the bond and results in a phenomenon that is widely know in the industry as “blistering.” Blistering is a major cause of rejected containers due to the degradation of aesthetic quality. The cost of rejected containers and the additional cost of individual container inspection are significant factors in a competitive marketplace.

Two types of substrates used by in-mold label converters are the most susceptible to undesirable blistering effect. The first type of substrate is cellulose-based, and the second type of substrate includes all extruded, non-woven plastic substrates. Extruded plastic substrates are known in the industry as “film” substrates, and are the most widely utilized by converters for the production of in-mold labels. The cellulose-based substrates, best known as “paper,” also act as a deterrent to the passage of air from one side of the label to the other. Thus, blistering and its potentially degrading effects are a substantial issue faced by all manufactures of in-mold labeled containers.

### III. SUMMARY OF THE INVENTION

The present invention provides an improved in-mold label having perforations and a method and apparatus for creating such labels. The in-mold label of the present invention substantially reduces blistering during the blow molding process. According to the present invention, the perforations are created in the in-mold label, preferably by mechanical means that is accomplished in-line with other aspects of the production of the in-mold label. Preferably, the perforations impair the aesthetics of the in-mold label as little as possible.

In one embodiment, the present invention provides a perforated in-mold label, comprising a substrate adapted for use as an in-mold label in a plastic container and at least one perforation in the substrate. The in-mold label may further comprises an adhesive material adapted to bond to the blow-molded container. In another embodiment, the in-mold label may have printing on a one side of the substrate and adhesive material on the other side of the substrate, wherein at least one perforation is larger on the adhesive side of the substrate than on the printing side of the substrate.

In another embodiment, the present invention provides a system for creating perforations in labels during the label manufacturing process. The system comprises a perforator, including at least one perforation application roll and at least one nip roll and a film or paper substrate passing through the perforator. The perforation application roll preferably comprises a shaft with pins attached at application-specified distances from each other. The nip roll preferably comprises a shaft mounted in such a way as to create a firm support for the substrate during the perforation process.

The present invention also provides a method for perforating in-mold labels with perforations, the method comprising the steps of: performing at least one in-mold label manufacturing procedure on an in-mold label in-line with perforating the in-mold label.

The present invention provides a system for producing blow molded containers with in-mold labels containing perforations, the system comprising an in-mold label having perforations and a blow molder unit adapted to incorporate the in-mold label into a blow-molded container.

### IV. BRIEF DESCRIPTION OF THE DRAWINGS

The accompanying drawings, which are incorporated in and constitute a part of the specification, illustrate a presently preferred embodiment of the invention, and, together with the general description given above and the detailed description of the preferred embodiment given below, serve to assist explaining the principles of the invention.

FIG. 1 is a front view of a plastic container with an in-mold label with part of the label and the sidewall of the container cut away to reveal how the in-mold label is embedded within the sidewall of the plastic container.

FIG. 2A is a side view of a glue-on label that has been mounted by adhesive to the exterior of a plastic container.

FIG. 2B is a side view of an in-mold label of a plastic container.

FIG. 3 is a schematic depiction of an extrusion blow molding process.

FIG. 4 is a perspective view of an in-mold label having perforations according to the present invention.

FIG. 5 is a cross-section taken along line 5-5 of the in-mold label with perforations of FIG. 4.

FIG. 6 is a schematic depiction of the preferred method for making perforations in labels as part of a web-fed, in-mold label manufacturing process.

FIG. 7 is a schematic depiction of the preferred method for making perforations in labels that are cut into individual sheets.

FIG. 8 is a perspective view of a perforator according to one embodiment of the present invention.

### IV. DETAILED DESCRIPTION OF THE INVENTION AND THE PREFERRED EMBODIMENT

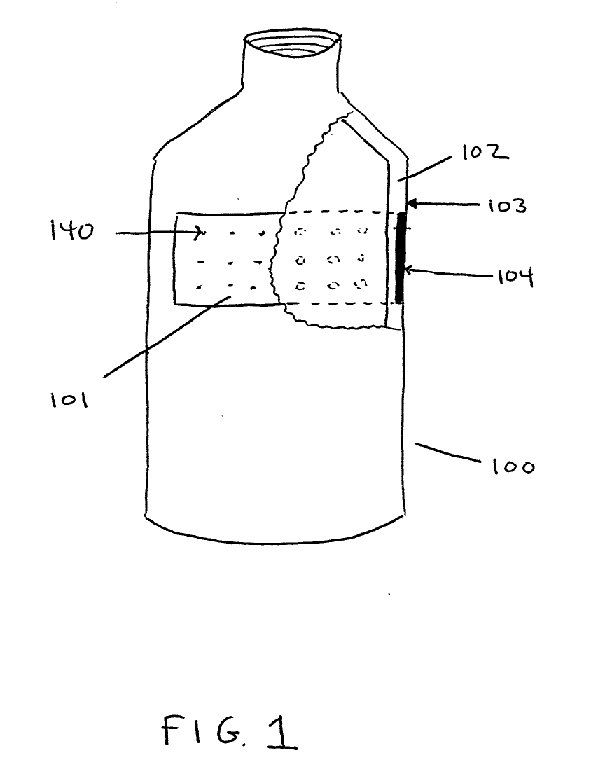

In the figures, like numerals indicate like parts. FIG. 1 is a front view of a plastic container 100 with an in-mold label 101 having perforations 140 according to the present invention. In FIG. 1, part of the in-mold label 101 and the sidewall 102 of the plastic container 100 are cut away to reveal how the in-mold label 101 is embedded within the sidewall 102 of the plastic container 100. The in-mold label 101 preferably is substantially contained within (and becomes part of) the sidewall 102 of the plastic container 100, with the outer surface 103 of the plastic container 101 nearly flush with the printed side 104 of the in-mold label 101.

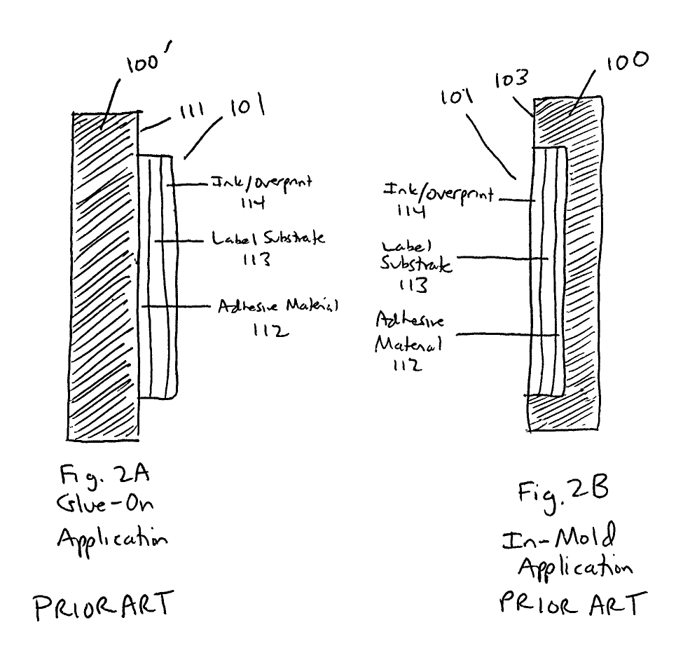

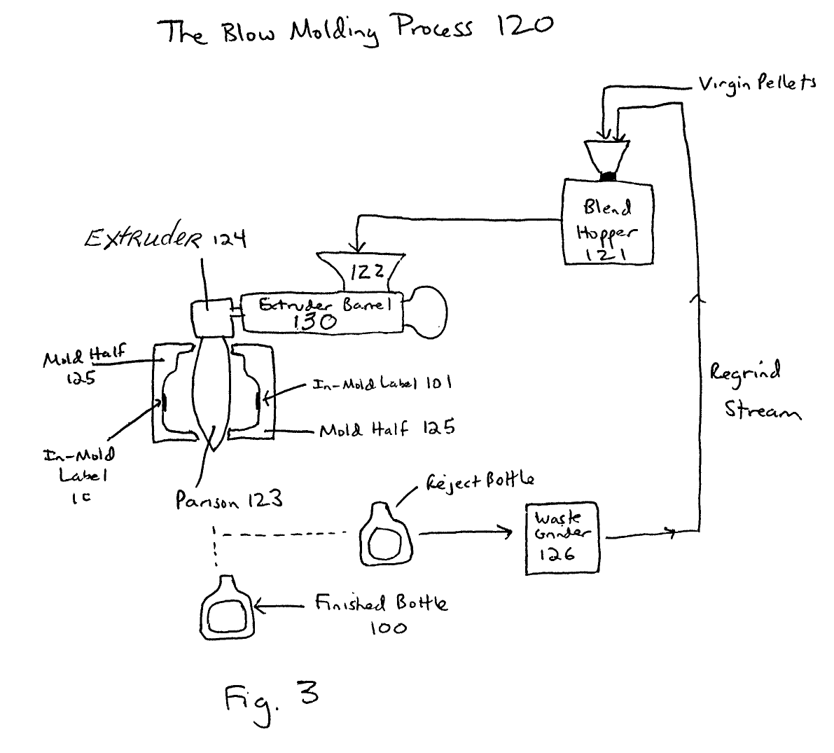

FIG. 2A depicts a side view of a label 101 that is attached with an adhesive to the outer surface 111 of a plastic container 100. FIG. 2B depicts a side view of an label 101 embedded in the plastic container 100. As shown in FIGS. 2A and 2B, the label 101 is generally comprised of three layers: the inner adhesive material layer 112; the label substrate 113; and the ink/overprint layer 114.

The in-mold label 101 is virtually flush with the outer surface 103 of the plastic container 100, resulting in a nearly smooth surface on the completed plastic container 100, while the label 101 that is glued-on protrudes outwardly by the combined thickness of the glue, substrate, and ink/overprint.

Preferably, the label substrate 113 of the in-mold label 101 of the present invention is comprised of a plastic film. The plastic film offers a variety of advantages over cellulose-based paper for use as the label substrate 113 in an in-mold label 101. First, extruded substrates become an essential part of the structure of the plastic container 100 once the blow molding process is complete, adding to the structural rigidity of the plastic container 100 and often reducing the necessary raw material used in production. In addition, film substrates are more easily recoverable. When a plastic container 100 has a flaw and is rejected after inspection, it is added back in to the beginning of the process, essentially as scrap plastic, in order to reduce cost and waste. With a paper substrate, the plastic container 100 cannot be recovered without removing the label, adding time, expense and complication to the process. With a film substrate in-mold label 101, the in-mold label 101 essentially becomes part of the plastic container 100 and can be recovered with the plastic container 100. In addition, film substrates heat and cool at nearly the same rate as the material in the plastic container 100, thereby reducing label panel bulging due to temperature variations.

In a preferred embodiment, the label substrate 113 is made of oriented or bi-axially oriented polypropylene plastic film available under the name “Poly-Tuf” from Mail-Well Label, Inc. located in Denver, Colo. This is a film made from polypropylene resin that is mineral-reinforced with blends of inert calcium (CaCO₃) and titanium dioxide (TiO₂) for whiteness and opacity. The plastic film is available in various thicknesses. The preferred thickness is in the range of approximately 3 to 7 mil., with about 4 mil. being particularly preferred.

The substrates may also be made from other extruded plastics. Examples include extruded mono-layer or multilayer plastic film currently used for in-mold labels 101 by the majority of in-mold label converters. One example, made by Arjobex North America located in Charlotte, N.C., with the trade name “Polyart,” is a biaxially oriented polypropylene (“BOPP”) available in thicknesses of 3.0 mil and heavier weights. Another example is “Kimdura,” which is a biaxially oriented polypropylene available from Kimberly-Clark with a thickness of 3.0 ml. or heavier.

There is also a plastic foam substrate used to produce in-mold labels. An example of such a hybrid is the multilayered “Dura-Core,” substrate manufactured by Owens-Illinois, Inc., located in Toledo, Ohio.

Another hybrid in-mold label substrate is named “Polyweave,” a high density polyethylene (“HDPE”) available from Polyweave International LLC of Memphis, Tenn. This substrate is self-adhering when heated, eliminating the need for adhesive. Polyweave is available in approximately 6.5 mil thickness, but it is more expensive than other substrates and has a lower grade printing surface.

The present invention is not limited to one particular type of substrate, and one skilled in the art will recognize that various extruded substrates, paper substrates, hybrids and other materials not described herein are all within the scope of the invention.

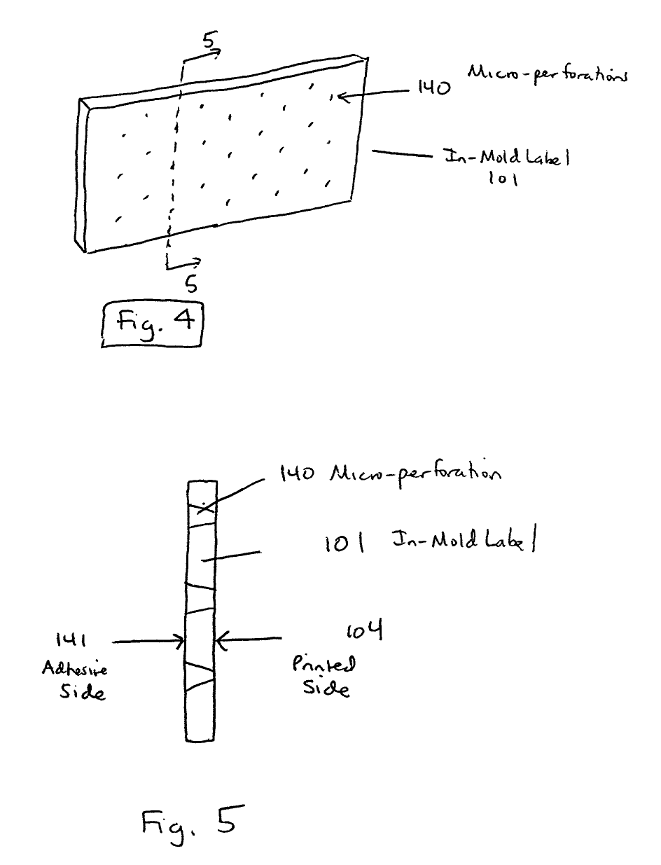

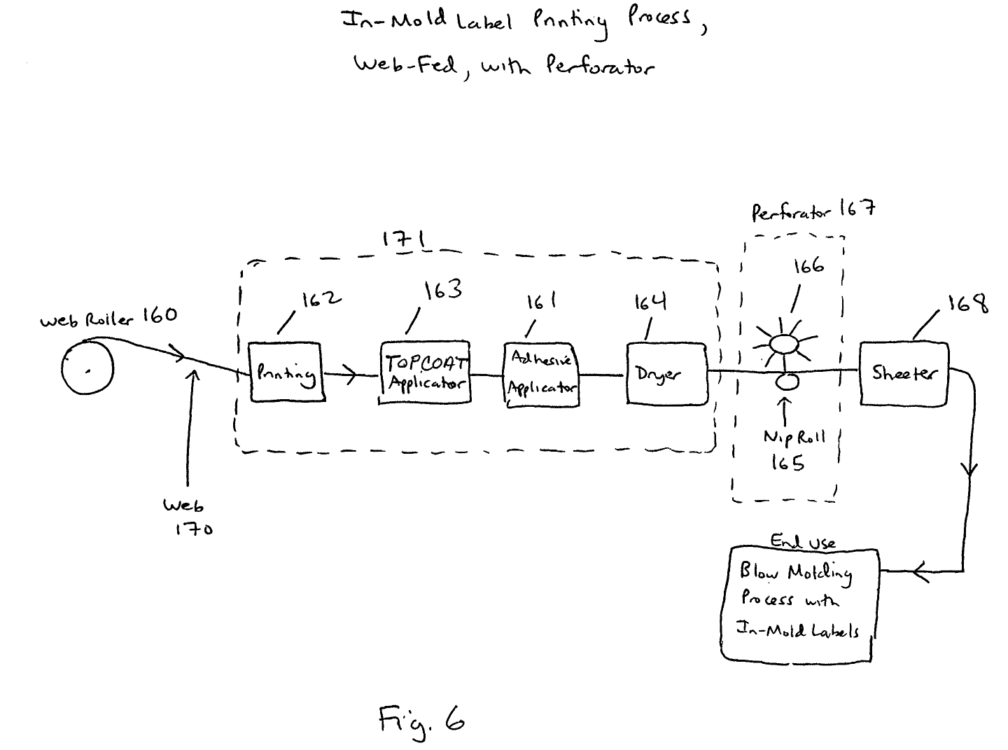

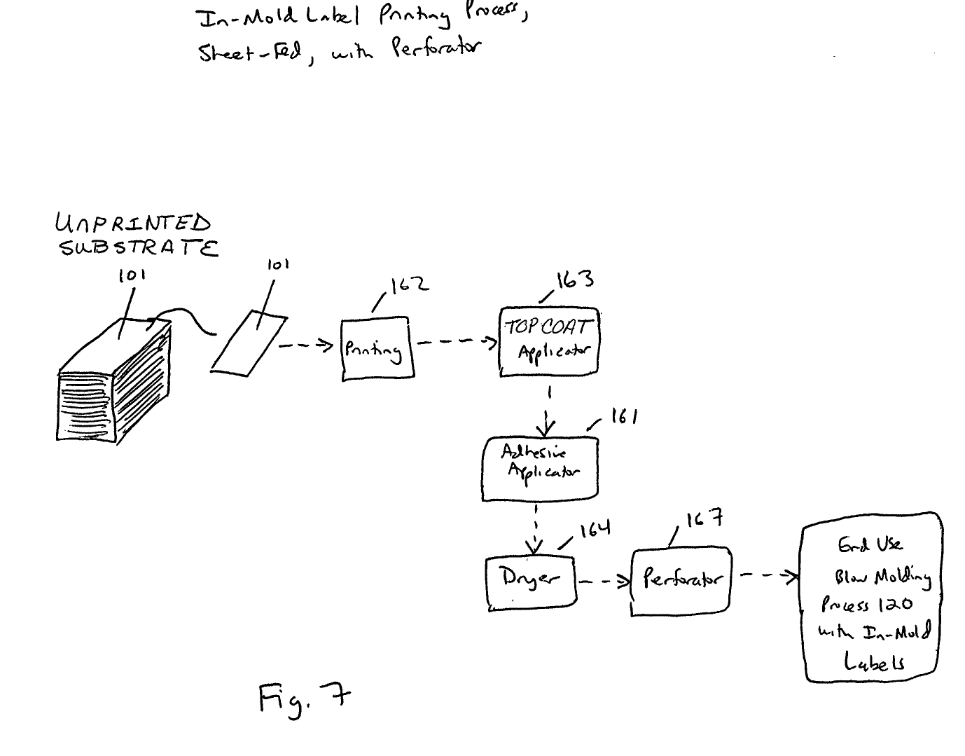

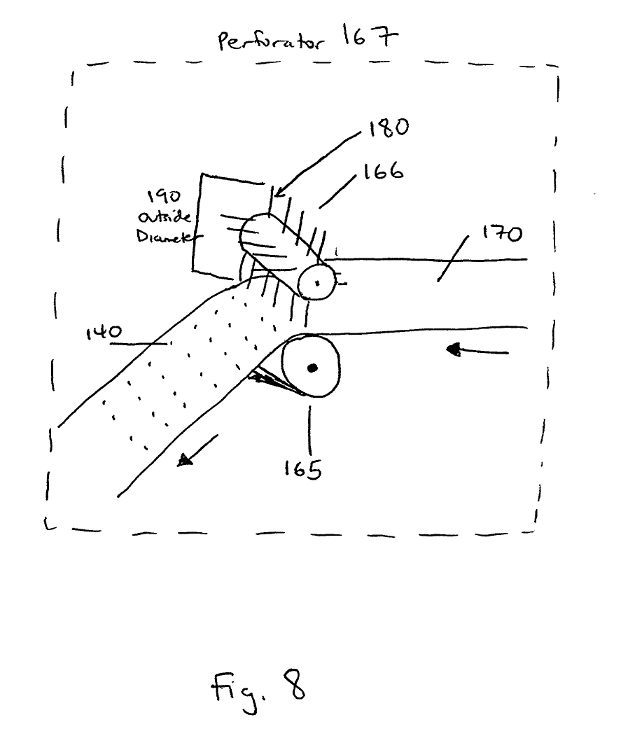

FIG. 3 depicts a rotary extrusion blow molding process 120 used in the blow molding industry. The present invention is not limited to a particular type of molding process and will operate with all types of molding equipment. The extrusion blow molding process 120 begins when granulated plastic resin material (source material) is placed in a hopper 121. The granulated resin then goes into the throat that puts the resin into the feed section of the extruder 122. The extruder is primarily comprised of a barrel, a screw, and a feed section. The screw forces the resin through the heated extruder barrel 130, where friction and heat melt the granulated resin into a molten state. The molten plastic is then pushed through the head tooling including a die and mandrel (not shown) in extruder head 124 to form the parison 123. The parison 123 at this stage is composed of molten plastic. Typically, the parison is in a generally tubular shape appropriate for the formation of a typical, molded container. However, depending on the final shape of the molded product, the parison may take other suitable configurations. The head tooling forms the parison 123 between the die and mandrel (not shown). The plastic is extruded out of the head tooling between the die (on the outside of the parison 123) and mandrel (on the inside of the parison 123) to form the parison 123. Parison air is blown through the mandrel to keep the parison 123 from collapsing, and the mandrel moves in relation to the parison 123 to change wall thickness of the parison 123.

Next, the parison 123 is placed between two mold halves 125. As the mold halves 125 come together, a blow-pin (not shown) is injected into the parison 123. This exerts a blow pressure forming the parison 123 to the geometric design of the mold cavity formed by the two mold halves 125. The air in the mold surrounding the parison 123 escapes through tiny gaps or vents between the mold halves 125.

Cooling within the mold halves 125 changes the molten material of the parison 123 back to a solid phase. As the parison 123 is completely cooled and solidified, it transitions into the finished plastic bottle 100. To cool the mold, the mold halves 125 are injected with chilled water, which flows through patterns of drilled channels throughout the mold halves 125. The water channels are typically designed to provide cooling throughout the perimeter of the plastic container 100 while concentrating more cooling in the thicker and pinch-off areas of the plastic container 100.

After the mold halves 125 are separated, each of the plastic containers 100 is mechanically removed from the mold and is then trimmed, tested and inspected by downstream equipment. Plastic containers 100 that do not pass inspection are diverted to a waste grinder 126, which grinds them into a form suitable for reuse as a source material in the container manufacturing process.

In-mold labeling occurs during the blow molding process 120. As discussed in relation to FIG. 2B, each in-mold label 101 generally comprises a label substrate 113 with a layer of adhesive material 112 applied to one side and a layer of ink/overprint 114 applied to the other side. One or more in-mold labels 101 are picked up by a robotic arm and positioned on the inside of the mold half 125 before the parison 123 is injected between the mold halves 125 through the extruder head 124. The in-mold label 101 should lie flat against the mold, with its ink/overprint 114 layer facing the wall of the mold. The in-mold label 101 is typically held in place through the use of vacuum ports located in the mold. As the in-mold label 101 is held in place, parison 123 is injected into the open mold, and the mold halves 125 close around the parison 123. As high pressure air is injected, the molten plastic that comprises the parison 123 activates the adhesive material 112 layer. The molten plastic of the parison 123 flows around the in-mold label 101 and conforms to the shape of the mold. As the molten plastic cools, the adhesive material 112 also cools and adheres to the solidifying parison 123 and the in-mold label 101 thereby becoming part of the plastic container 100.

For proper adhesion to occur, the adhesive material 112 must first melt or activate, because the necessary mechanical bonding takes place while the adhesive material 112 and plastic are both in a molten state and compressed against each other with blow-air. In addition, it is desirable that the adhesive material 112 and molten plastic both cool and solidify at similar rates while under blow-air pressure in order to maintain good mechanical bonding. In general, typical adhesives for this purpose include solvent based, ultra violet cured adhesives. A preferred adhesive is Adcote 33DW1981G* 180° F. available from the Rohm & Haas Company, Chicago, Ill. Other suitable adhesives may include Adcote 31DW2062-UV and 33X186 also available from Rohm & Haas.

Absent the present invention, variations during the blow molding process of heat, time, pressure and materials can cause the entrapment of gases between the label 101 and container 110. For example, if the adhesive material 112 is still in a molten state when the blow-air is turned off, some vapor can still be located between the label 101 and container 110 and blistering can occur as the plastic container 100 cools. Experience and testing indicates that higher blow-air pressures result in better in-mold label 101 bonds to the plastic container 100. Preferably, the blow-air should turn on as soon as the mold halves 125 close and remain on until the mold halves 125 open.

Mold halves 125 are cooled with chilled water to allow the adhesive material 112 to solidify while under pressure from the blow-air. The flow rate of the cooling water influences the consistency of the mold temperature, and experience indicates that the differences between the temperature of the cooling water going in to the mold and the cooling water coming out of the mold should be less than five degrees Fahrenheit. The cooling water temperature should also be such that the mold temperature is cool enough to allow the adhesive material 112 to solidify while under pressure from the blow-air or else, again, blistering of traditional in-mold labels 110 can occur. The optimum cooling temperature depends on the container geometry, the thickness of the container wall, the parison temperature, the time that the blow-air is on, the type of plastic polymer, and any cooling water additives.

FIGS. 4 and 5 illustrate the preferred in-mold label 101 of the present invention, which provides a solution for many of the blistering problems previously encountered. As described above, variations in materials, temperatures, cooling time, and other variables can cause gases to become trapped behind the in-mold label 101 during the blow molding process 120. The perforations 140 in the in-mold label 101 of the present invention allow the gases and other volatiles to escape. Testing has shown that perforations 140 as described herein substantially reduce or eliminate blistering of the in-mold label 101. Blistering is reduced because the gases are not trapped during the molding and cooling portions of the manufacturing process.

In a preferred embodiment, the perforations 140 are round and are spaced and sized so as to allow an adequate amount of gas to escape to substantially prevent blistering while not having a substantial effect on the overall appearance of the in-mold label 101. The perforations 140 in the preferred embodiment are approximately one-quarter inch apart in each direction. Each row of perforations 140 is preferably one-half inch from each of the parallel, adjacent rows. In the preferred embodiment the holes in each row are staggered approximately one-quarter inch from the holes in the adjacent row(s), resulting in a “diamond” appearance. The present invention, however, is not limited to the above-described configuration, and other perforation designs will be apparent to those skilled in the art. For example, different configurations of the perforations 140, including various geometric or random patterns, are within the scope of the invention. In addition, the pattern density of the perforations 140 could be varied. For example, the density of perforations 140 could vary with the printing on the label, the curvature of the bottle where the in-mold label will be placed, or the geometric location on the in-mold label 101 (e.g. more perforations in the center). In one embodiment, the density of perforations 140 can be individualized for each in-mold label 101 by corresponding the circumference of the perforation application roll 166 (described in relation to FIG. 8) to the length of the in-mold label 101 and including a registration mark (not shown) on each in-mold label 101 so as to synchronize the perforator 167 (described in relation to FIG. 8) with each in-mold label 101.

Preferably, the perforations 140 are placed approximately ¼ inch to 2 inches apart. Smaller distances between perforations 140 can weaken the structural integrity of the in-mold label 101 and have an adverse effect on aesthetics, without providing a substantial performance improvement. Distances greater than approximately 2 inches do not allow adequate amounts of gas to escape from behind the in-mold label 101. In a preferred embodiment, the perforations 140 are placed approximately one-half inch apart.

Perforations 140 may be straight tubes of equal width throughout. These straight perforations 140 are between approximately 0.001 inch and 0.1 inch in width, i.e., diameter in the case of circular openings. Widths less than approximately 0.001 inch may not allow an adequate amount of gas to escape, and larger sizes may result in undesirable aesthetic characteristics. Preferably the holes or openings of the perforation are between about 0.0015 and 0.003 inch in width, with 0.0025 inch being particularly preferred.

FIG. 5 illustrates a preferred embodiment, where the perforations 140 are not the same width throughout their length. The perforations are larger on the adhesive side 141 than on the printed side 104 of the label substrate 112 in order to facilitate the escape of the trapped gases and are roughly circular in shape when viewed from either side 104, 141. In other words, each perforation 140 preferably forms a “cone” or “funnel” to help remove gases trapped between the adhesive side 141 of the label substrate 112 and the molten plastic of the parison 123 during molding. Preferably, the perforations 140 are between approximately 0.001 inch and approximately 0.007 inch on the side with the smaller hole (i.e., the printed side). Smaller sizes of holes may not allow for an adequate amount of gas to escape, and sizes larger than approximately 0.007 inch can result in undesirable aesthetic characteristics. In the preferred embodiment, the smaller hole on the perforation 140 is approximately 0.003 inch.

Preferably, the perforations 140 have a ratio between the larger hole and the smaller hole of between approximately 2:1 and approximately 4:1. If the larger hole is less than approximately twice the size of the smaller hole, the pin 180 required to produce the perforation 140 is susceptible to breakage. If the larger hole is more than four times the size of the smaller hole, there is a possibility that a complete perforation 140 might not be created because of the less-aggressive taper. In the preferred embodiment, the larger hole of the perforation 140 is approximately 0.010 inch, which is roughly three times the size of the smaller hole of 0.003 inch.

One skilled in the art, however, will recognize that other shapes and sizes of perforations 140 are within the scope of the invention. Other shapes include slits, triangular holes, square holes, etc. The perforations 140 may be of any size and shape that allows gases to escape from behind the in-mold label 101. In addition, the larger hole, if any, of the perforation 140 can be oriented to either side 104 or 141 of the in-mold label 101, and is not limited to the adhesive side 141. In general, it is desirable to provide a size, shape, and number of perforations 140 that creates sufficient ventilation to avoid blistering while minimizing any adverse aesthetic effects on the in-mold label 101.

The perforations 140 are made in the in-mold label 101 before the in-mold label 101 is introduced into the blow molding process 120. Preferably, the perforations are created as a process in-line, or in a continuous manufacturing procedure, with in-mold label manufacturing procedures 171 (as depicted in FIG. 6). There are a wide variety of in-mold label manufacturing procedures 171. Preferably, a web-fed in-mold label manufacturing process 171 is used, where the label substrate 112 is in web form and initially stored on a roll. When the in-mold label manufacturing procedure 171 is web-fed, all aspects of the procedure are accomplished in a continuous manufacturing procedure, or in-line. Alternatively, the in-mold label manufacturing procedures 171 can be sheet-fed, where the label substrate 112 is cut into individual sheets before being printed.

FIG. 6 shows a preferred embodiment where the in-mold label manufacturing procedure 171 is accomplished by the web-fed method. The web roller 160 is used to store the label substrate 112 on a roll for continuous distribution. Various rollers (not shown) pull the web 170 through the in-mold label manufacturing procedure 171 and cause the web 170 to unroll from the web roller 160. The web 170 is pulled through the in-mold label manufacturing procedure 171 by the use of rollers and nip rolls, a method that is known in the art. The in-mold label manufacturing procedure 171 can consist of one or more printing units 162, a top coat applicator 163 and an adhesive applicator 161 followed by a dryer 164, all connected in-line. For example, the in-mold label manufacturing procedure 171 could comprise only a printer 162, or a printer 162 connected in-line with an adhesive applicator 161. Generally, a series of in-mold labels 101 are created on the continuous web 170 as the web 170 is pulled through the in-mold label manufacturing procedure 171 before eventually being cut into individual sheets of in-mold labels 101 by a sheeter 168.

In the embodiment shown in FIG. 6, the web 170 is pulled from the web roller 160 and enters the printer 162. The printer 162 may comprise any number of different printing devices known in the art. When the in-mold label manufacturing procedure 171 is web-fed, the printer 162 preferably can be a combination of Gravure, lithography (i.e., offset), and flexography methods. Optionally, after the printer 162, the web 170 enters s top coat applicator 163 which applies a protective layer of chemicals. The web 170 then enters the adhesive applicator 161. The method of applying adhesive 112 via an adhesive applicator 161 is known in the art. After the adhesive 112 is applied, the web 170 enters the dryer 164, which is known in the art.

The topcoat 114 is applied to the web 170 by flexographic means (a process well known in the industry). The flexographic (“flexo”) unit utilizes a line laser engraved anilox cylinder for application of top coat to the printed web. The cylinder engraving is designed to provide an even and controllable volume of topcoat. The anilox roller is engraved to the follow specifications: 210 lines per inch, cell angle of 30 degrees, cell diameter of 109 microns, cell depth of 28 microns and a calculated application volume of 7.2 billion cubic micron per square inch.

A preferred topcoat is Mira-Gloss 4100 available from the Rohm & Haas Company, Chicago, Ill. Other suitable topcoats may include UV Inmold Lacquer RMW 016119 available from Flint Inks, St-Leonard, Quebec, Canada and UV Lacquer 10PQ04Y-605, available from Hostmann-Steinberg, St-Laurent, Quebec, Canada. Generally, these coatins are ultra violet cured lacquer coatings.

Preferably in-line with the in-mold labeling manufacturing procedure 171, and before sheeter 168, is a perforator 167. The perforator 167 creates the perforations 140 in the in-mold label 101, and is described in detail in relation to FIG. 8. After the web 170 is threaded through the perforator 167, the web 170 enters the sheeter 168, which cuts the web 170 into individual sheets in order to create the final in-mold labels 101. After the individual in-mold labels 101 are completed, they can be used in the blow molding process 120 as described above.

There is flexibility in the order and inclusion of systems in the in-mold label manufacturing procedure 171. For example, in one preferred embodiment, the location of the nip roll 165 and the perforation roller 166 may be inverted from that shown in the process of FIG. 6 to facilitate adjustment and promote safety. Similarly, in a preferred embodiment the adhesives or the top coat protection is applied before the web 170 goes through the perforator 167. The perforations 140 are applied by the perforator 167 after printing and application of the adhesives and top coat protection in order to eliminate any chance that the ink, adhesive material 112 or topcoat 114 will clog the perforations 140. The heat of the blow molding process 120 may clear any clogging in the perforations 140, but such a result is not guaranteed. Other variations may be made.

FIG. 7 shows a preferred embodiment where the in-mold label manufacturing procedure 171 is accomplished using the sheet-fed method. The label substrate 113 for the in-mold labels 101 are cut into individual sheets. Preferably, the sheets are fed into the printer 162 using an automated technique such as a robotic arm or a feedboard. After the printer 162, the in-mold label 101 sheets are fed into one or more of a top coat applicator 163, adhesive applicator 161, and a dryer 164. The in-mold label 101 sheets can be transported between each stage of the in-mold label manufacturing procedure 171 using automated or manual techniques. After exiting the dryer 164, the in-mold label 101 sheets are fed into the perforator 167, which is adapted for use with individual sheets. After being perforated, each in-mold label 101 is available for use in the blow molding process 120.

A preferred embodiment of the perforator 167 is illustrated in detail in FIG. 8. The web 170 is threaded between a nip roll 165 and a perforation application roll 166. Both the nip roll 165 and the perforation application roll 166 rotate as the web 170 passes between them and preferably assist in pulling the web 170 toward the sheeter 168. As the web 170 passes through, pins 180, which are attached to the perforation application roll 166, pierce the web 170 and create perforations 140. Therefore, after the web 170 passes between the nip roll 165 and the perforation application roll 166 the desired perforations 140 have been created on the web 170. As discussed previously, it is preferred that the perforations 140 are created from the adhesive side 141 to the printed side 104 of the label substrate 112. However, the nip roll 165 and perforation application roll 166 can be inverted relative to the substrate 112 if it is desired that the perforations 140 be created from the other side (i.e., the printed side 104).

The nip roll 165 provides firm support, and acts as a counter roll, for the web 170 as the perforations 140 are made. The nip roll 165 is preferably made of pliable material with a durometer reading of between approximately 25 and 45 into which the pins 180 can penetrate. The nip roll 165 is rotably attached to the perforator 167 in such a way that it can rotate as the web 170 passes next to it, and preferably will assist in pulling the web 170. In a preferred embodiment, the nip roll 165 has a length of 20.125 inches and a diameter of 3.055 inches. One of ordinary skill in the art will recognize that other dimensions can be acceptable.

The perforation application roll 166 operates opposite of the nip roll 165. Preferably, the perforation application roll 166 is made of steel. The perforation application roll 166 is rotably attached to the perforator 167 in such a way that it can rotate with the web 170, and preferably will assist in pulling the web 170. In a preferred embodiment, holes are spaced approximately one-half inch apart around the circumference, and along the length of, the perforation application roll 166, and pins 180 are securably attached into each such hole. In a preferred embodiment, the perforation application roll 166 has a length of 20.125 inches and a diameter of 2.225 inches. The outside diameter 190 between the tips of the pins 180 is 4.1 inches. It is preferred that the pins 180 are of consistent length so as to provide a consistent depth of penetration through the web 170. In the preferred embodiment, the depth of penetration is approximately 0.006 inch.

The pins 180 are mounted on the perforation application roll 166. In the preferred embodiment, each pin 180 has a length of approximately 1.250 inches and the application end or tip that is approximately 0.935 inch from the surface of the perforation application roll 166. Preferably, the pin 180 is tapered at the application end in order to create the “cone”- or “funnel”-style perforation 140 discussed in relation to FIG. 5. In a preferred embodiment, the pin 180 tapers from a width of approximately 0.039 inch to a point at the end of the pin 180. Such a pin 180 can be used to create a preferred perforation 140 with a larger hole of approximately 0.010 inch on one side of the label 101 and a smaller hole of approximately 0.003 inch on the other side. Other variations of tapering are possible, as long as adequate perforation 140 holes sizes (as described above) are achieved.

Other forms of the perforator 167 are possible and remain within the scope of the present invention. For example, if a sheet-fed label manufacturing procedure 171 is used, the perforator 167 must be adapted accordingly. In that case, a perforator 167 can use a flat or rotary die-stamper to create perforations 140 in the in-mold label 101 on a sheet-by-sheet basis. The perforator 167 could also use a rotary mechanism similar to the perforation application roll 166 and nip roll 165 adapted to be used with individual in-mold label 101 sheets. Alternately, other methods can be used to create the perforations 140, and one skilled in the art will recognize that many alternative designs of the perforator 167 will be within the scope of the present invention.

The invention is not limited to the above-described preferred embodiments. Other embodiments will be apparent to those skilled in the art from consideration of the specification disclosed herein. It is intended that the specification be considered as exemplary only, with the scope of the invention being indicated by the following claims.

1. A method for forming a product containing a label embedded therein by blow molding comprising:
placing a pre-printed label in a mold, said label containing one or more perforations sufficient to lessen the entrapment of gases by the label during the molding process thereby preventing blistering;
placing a parison of liquid plastic in the mold;
blowing air into the mold to conform the liquid plastic to the shape of the mold; and
cooling and curing the plastic in the shape of the product.

2. The process of claim 1 wherein the product is in the form of a hollow container.

3. The process of claim 1 wherein the perforations have an opening between approximately 0.00 1 inch and 0.1 inch in diameter.

4. The process of claim 2 wherein the perforations comprise an opening between approximately 0.001 inch and 0.1 inch in diameter.

5. The process of claim 3 wherein the perforations are located between approximately 0.25 to 2 inches from one another.

6. The process of claim 4 wherein the perforations are located between approximately 0.25 to 2 inches from one another.

7. The process of claim 3 wherein the openings of at least one perforation are wider on one side of the label than on the other.

8. The process of claim 4 wherein the openings of at least one perforation are wider on one side of the label than on the other.

9. The process of claim 7 wherein the label includes an adhesive substance on one side and the perforation is wider on that side of the label than on the other.

10. The process of claim 8 wherein the label includes an adhesive substance on one side and the openings of the perforation are wider on that side of the label than on the other.

20. In a method for forming a molded product containing a label embedded therein the improvement comprising:
placing a pre-printed label in a mold, said label containing one or more perforations sufficient to lessen the entrapment of gases by the label during the molding process thereby preventing blistering.

21. The process of claim 20 wherein the product is in the form of a hollow container.

22. The process of claim 20 wherein the perforations have an opening between approximately 0.001 inch and 0.1 inch in diameter.

23. The process of claim 21 wherein the perforations have an opening between approximately 0.001 inch and 0.1 inch in diameter.

24. The process of claim 22 wherein the perforations are located between approximately 0.25 to 2 inches from one another.

25. The process of claim 23 wherein the perforations are located between approximately 0.25 to 2 inches from one another.

26. The process of claim 22 wherein the openings of at least one perforation are wider on one side of the label than on the other.

27. The process of claim 23 wherein the openings of at least one perforation are wider on one side of the label than on the other.

28. The process of claim 26 wherein the label includes an adhesive substance on one side and the perforation is wider on that side of the label than on the other.

29. The process of claim 27 wherein the label includes an adhesive substance on one side and the openings of the perforation are wider on that side of the label than on the other.

30. A label for use in forming a molded product containing the label embedded therein, said label comprising:
a substrate;
one or more perforations in the substrate sufficient to lessen the entrapment of gases by the label during molding thereby preventing blistering.

31. The label of claim 30 further comprising printing on at least one side of the substrate, and adhesive on at least one side of the substrate.

32. The label of claim 30 wherein the perforations have an opening between approximately 0.001 inch and 0.1 inch in diameter.

33. The label of claim 31 wherein the perforations have an between approximately 0.001 inch and 0.1 inch in diameter.

34. The label of claim 32 wherein the perforations are located between approximately 0.25 to 2 inches from one another.

35. The label of claim 33 wherein the perforations are located between approximately 0.25 to 2 inches from one another.

36. The label of claim 34 wherein the openings of at least one perforation are wider on one side of the label than on the other.

37. The label of claim 35 wherein the openings of at least one perforation are wider on one side of the label than on the other.

38. The label of claim 36 wherein the label includes an adhesive substance on one side of the substrate and the perforation is wider on that side of the label than on the other.

39. The label of claim 37 wherein the label includes an adhesive substance on one side of the substrate and the perforation is wider on that side of the label than on the other.

40. The label of claim 30 wherein the substrate comprises an extruded plastic film.

41. The label of claim 30 wherein the label contains a plurality of perforations configured in parallel rows.

42. The label of claim 41 wherein said perforations are approximately one-half inch apart in said rows and the perforations in each row are offset from perforations in adjacent rows by approximately one-quarter inch.

43. The label of claim 41 wherein the openings of at least one perforation are circular in shape.

44. The label of claim 36 wherein the ratio between the width of the opening of the perforation on the respective sides is between about two-to-one and four-to-one.

45. The label of claim 37 wherein the ratio between the width of the opening of the perforation on the respective sides is between about two-to-one and four-to-one.
